(19) United States
(12) Patent Application Publication
(10) Pub. No.: US 2011/0307122 A1
(43) Pub. Date: Dec. 15, 2011

(54) DEVICE AND METHOD FOR CONTROLLING THE DRIVING BEHAVIOR OF A VEHICLE WHEN APPROACHING A STOPPING POINT

(75) Inventors: Torsten KANNING, Eltville-Erbach (DE); Justus ILLIUM, Mainz (DE)

(73) Assignee: GM GLOBAL TECHNOLOGY OPERATIONS LLC, Detroit, MI (US)

(21) Appl. No.: 13/155,991

(22) Filed: Jun. 8, 2011

(30) Foreign Application Priority Data
Jun. 9, 2010 (DE) 102010023198.3

(51) Int. Cl. G06F 7/00; G01C 21/00

(52) U.S. Cl. 701/1

(57) ABSTRACT

A device is provided for controlling the driving behavior of a vehicle when approaching a stopping point with a sensing device, which determines the distance between the vehicle and the stopping point, and with an evaluation device which taking into account at least the current vehicle speed determines a rolling distance to the stopping point, which the vehicle will cover with disconnected operational connection between vehicle drive and the driven vehicle wheels. A signaling device, upon reaching of the rolling distance, generates a disconnection signal for disconnecting the operational connection.

### CROSS-REFERENCE TO RELATED APPLICATION

This application claims priority to German Patent Application No. 102010023198.3, filed Jun. 9, 2010, which is incorporated herein by reference in its entirety.

### TECHNICAL FIELD

The technical field relates to a device and a method that exclusively or in addition to further functions serve for controlling the driving behavior of a vehicle when the vehicle approaches a stopping point located ahead in driving direction.

### BACKGROUND

The term driving behavior within the scope of the present invention is to mean for example the driving dynamics that is the temporal course of a vehicle speed. A stopping point located ahead can for example be a red traffic light, a stop sign, other roadway users, a traffic congestion or an obstacle for example in the form of a wall. In brief: generally a forecast stoppage or situations meaning a forecast stoppage of the vehicle.

From the German disclosure publication DE 10 2007 018 733 A1 a method and a device for determining a speed function for decelerating a vehicle and a deceleration system for a vehicle can be gleaned. There, the fuel consumption of the vehicle is to be reduced in particular in that the drive engine is operated in coasting mode for as long as possible a time. For determining the speed function for decelerating the vehicle a deceleration distance of the vehicle is determined with a starting speed of the vehicle at the start of the deceleration distance and a setpoint end speed of the vehicle at the end of the deceleration distance. From this a speed function is determined, which describes a speed of the vehicle from the starting speed to the setpoint end speed via the deceleration distance. The deceleration distance of the vehicle, during which the vehicle is to be decelerated, can for example be determined by a driver assist system, which for example senses a current traffic situation as well as traffic signs or traffic light systems using a distance radar and/or a camera. Particularly if the end of the deceleration distance is a stopping point or a forecast stoppage will the extended operation of the vehicle in coasting mode result in phases in which a minimum engine rotational speed is undershot and the vehicle has to be kept in operation through fuel supply. This results in an unnecessary fuel consumption and in a suboptimal operation of the vehicle drive that can result in an uncomfortable driving behavior of the vehicle.

In view of the foregoing, at least one object of stating a device and a method for the further lowering of the energy consumption of a vehicle when approaching a stopping point with comfortable driving behavior at the same time. In addition, other objects, desirable features and characteristics will become apparent from the subsequent summary and detailed description, and the appended claims, taken in conjunction with the accompanying drawings and this background.

### SUMMARY

Accordingly, a device for controlling the driving behavior of a vehicle when approaching a stopping point is provided with a sensing device which determines the distance between the vehicle and the stopping point, and with an evaluation device, which determines a rolling distance to the stopping point which the vehicle will cover with disconnected operational connection between vehicle drive and driven vehicle wheels taking into account at least the current vehicle speed, wherein a signaling device on reaching the rolling distance generates a disconnection signal for disconnecting the operational connection.

A first substantial advantage is in a considerable lowering of the energy consumption of the vehicle when driving up to a stopping point, without the driving comfort being impaired “over the last meters”. Through the disconnecting of the operational connection between the vehicle wheels and a vehicle drive, a vehicle, which for example approaches a stopping point in coasting mode, upon reaching of a certain minimum engine rotational speed is enabled with an additional rolling phase for rolling up to the stopping point. This rolling phase is advantageously unaffected by influences of a drive rotating at low revolutions. For example the jerking or shuddering known from combustion engines at low rotational speed in coasting mode, while the drive for the optimization of its energy requirement can be operated with minimum rotational speed or even completely switched off. Here, the term “energy” is to mean the vehicle drive energy, that is for example the fuel supply in the case of a vehicle with combustion engine and/or the electricity supply in the case of a vehicle with electric motor.

The sensing device can for example be designed as distance radar. In addition, sensing devices are conceivable, which by means of image information gained from the vehicle surroundings determine the distance between stopping point and vehicle. The term evaluation device within the scope of the present invention is to mean a device for evaluating various influence quantities influencing the rolling distance of the vehicle. For taking into account the current vehicle speed a speed signal, which as a rule is provided for activating a speed display, and which is already available in the vehicle can be utilized. Alternatively to a rolling distance the evaluation device in corresponding manner and equivalent to the rolling distance can also determine a time for the start of the rolling phase of the vehicle. Practically, this can be the time at which the vehicle has the necessary rolling speed in order to cover the distance between current vehicle position and stopping point alone in a rolling manner that is without additional engine drive.

With vehicles having a manual transmission the disconnecting of the operational connection between vehicle drive and the driven vehicle wheels can be effected through decoupling the vehicle transmission. The decoupling can for example be carried out through the actuation of a clutch pedal by the vehicle driver (in the following called the driver).

The disconnection signal for disconnecting the operational connection between vehicle wheels and vehicle drive generated by the signaling device can be an emitted for example visual and/or acoustic disconnection signal perceptible to the driver. The disconnection signal brings to the attention of the driver that at the current time disconnecting the operational connection is practical.

In an embodiment the disconnection signal brings about an automatic disconnecting of the operational connection between the vehicle drive and the driven vehicle wheels. Thus, the disconnecting of the operational connection can take place automatically and without active action on the part of the driver. This advantageously serves for relieving the driver and thus increases the safety for the vehicle occupants and/or other roadway users. In addition, through the automatic disconnecting of the operational connection, a strategy for lowering the energy consumption is consistently pursued without possible impairment through a negligent driver who fails to react to the perceptible disconnection signal being.

The automatic disconnecting of the operational connection can for example be effected through a disconnection device. In the case of vehicles with a manual transmission the disconnection device for example comprises a decoupling unit for decoupling the vehicle transmission or a transfer of the transmission position in the “idle” position.

According to a further embodiment, the sensing device comprises a camera system. Through this embodiment, camera systems, which are already present in the vehicle because of other functionalities, for example of a driver assist system, can be utilized. The data gained from the camera system can for example be evaluated by an image processing unit, wherein the distance between the vehicle and the stopping point is determined from the data.

According to another embodiment the sensing device generates ambient information representing the vehicle surroundings, wherein the evaluation device determines the rolling distance taking into account the ambient information. By taking into account ambient information the rolling distance is determined with a particularly high accuracy. In addition, ambient information can be taken into account as a function of the determined rolling distance influence the safety of the vehicle occupants.

The ambient information can for example be information regarding the traffic situation in the vehicle surroundings, information relating to weather conditions, for example the wind direction, the roadway surface, etc. There, ambient information with respect to other roadway users is also conceivable, wherein for example the shortening of the rolling distance reduces the risk of a collision between vehicle and the other roadway users.

According to another embodiment a navigation device generates topological information representing a topology of the vehicle surroundings, wherein the evaluation device determines the rolling distance taking into account the topological information. Thus, a particularly accurate calculation of the rolling distance for example in the case of a roadway with a downhill and/or uphill gradient is provided.

The navigation device can be a navigation system already present in the vehicle, which determines topological information using stored map data and simultaneously determines the current position of the vehicle in the topology by evaluating for example a GPS signal (Global Positioning System). The topological information provided by the navigation device can for example be information regarding the roadway located in driving direction and extending as far as to the stopping point with respect to a roadway uphill gradient and/or a roadway downhill gradient.

The method for controlling the driving behavior of a vehicle when approaching a stopping point provides that the distance between the vehicle and the stopping point is determined, wherein taking into account at least the current vehicle speed a rolling distance to the stopping point is determined, which the vehicle will cover with disconnected operational connection between vehicle drive and driven vehicle wheels, and wherein upon reaching of the rolling distance a disconnection signal for disconnecting the operational connection is generated. Thus, a particularly simple method for controlling the driving behavior of a vehicle which also optimizes the energy consumption of a vehicle is realized.

In an embodiment of the method, the operational connection between vehicle drive and driven vehicle wheels is automatically disconnected upon emission of the disconnection signal. This configuration, through the automatic intervention in the vehicle dynamics of the vehicle, makes possible a simple operation without an active intervention by the driver being necessary.

In another embodiment of the method, ambient information is generated which represents the vehicle surroundings, wherein the rolling distance is determined taking into account the ambient information. Thus a particularly practical method is stated, which taking into account additional influence quantities, determines the rolling distance with increased accuracy and safety for vehicle occupants and other roadway users.

In another embodiment, topological information is generated which represents the topology of the vehicle surroundings, wherein the rolling distance is determined taking into account the topological information. By taking into account the topological information particularly important for determining the rolling distance the accuracy of the rolling distance is further increased.

### BRIEF DESCRIPTION OF THE DRAWINGS

The present invention will hereinafter be described in conjunction with the following drawing figures, wherein like numerals denote like elements, and:

FIG. 1 is an exemplary embodiment of a device; and

FIG. 2 is schematically the sequence of the method according to an embodiment.

### DETAILED DESCRIPTION

The following detailed description is merely exemplary in nature and is not intended to limit application and uses. Furthermore, there is no intention to be bound by any theory presented in the preceding background or the following detailed description.

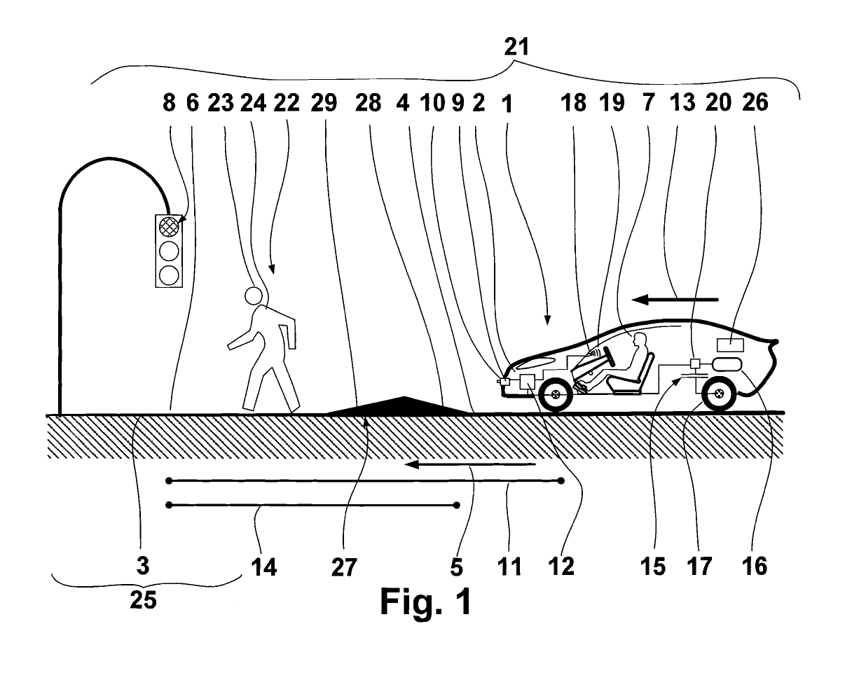

FIG. 1 shows a device 1 according to the invention in a vehicle 2 traveling on a roadway 3 (e.g., a road 4) in driving direction 5. Seen from the perspective of the vehicle 2 a stopping point 6 is located ahead in driving direction 5 which is directly perceptible by a driver 7 through a red traffic light 8. A sensing device 9 with a camera system 10 detects the red traffic light 8 and determines the current distance 11 between the vehicle 2 and the stopping point 6 subject to evaluation of image information gained.

An evaluation device 12 generates information from a vehicle speed signal, which information represents the current vehicle speed 13. Taking into account the current vehicle speed 13 the evaluation device 12 determines a rolling distance 14 to the stopping point 6 which the vehicle 2 with a disconnected operational connection 15 between a vehicle drive 16 and vehicle wheels 17 will cover alone that is in the so-called idle operation in a rolling manner. When the vehicle 2 has approached the stopping point 6 up to a distance corresponding to the rolling distance 14, a signaling device 18 emits a disconnection signal 19 for disconnecting the operational connection 15 between vehicle drive 16 and vehicle wheels 17. The disconnection signal 19 is perceptible to the driver 7 and is simultaneously sent to a disconnection device 20. When the disconnection device 20 receives the disconnection signal 19 it automatically disconnects the operational connection 15.

The sensing device 9 generates information representing the vehicle surroundings 21. Taking into account this information, for example regarding ambient influences 22 for example in the form of another roadway user 23, the evaluation device 12 determines the rolling distance 14. In the case shown in FIG. 1 the roadway user 23 is a pedestrian 24 located on the roadway shoulder, who, in the surroundings 25 of the red traffic light 8—through the although improbable but possible crossing of the roadway 4 can constitute an obstacle to the vehicle 2. Accordingly, the rolling distance 14 is suitably shortened taking into account the pedestrian 24.

A navigation device 26 generates information representing a topology 27 of the vehicle surroundings 21 in the form of an uphill gradient 28 and a downhill gradient 29. The evaluation device 12 also takes into account the topological information when determining the rolling distance 14.

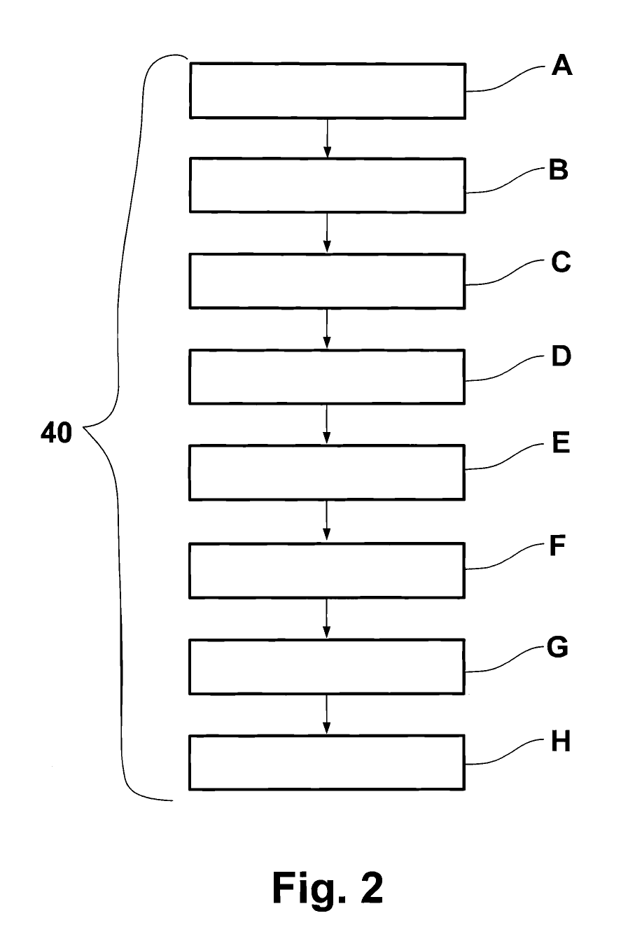

FIG. 2 shows schematically a possible sequence of the method 40. The method commences in method step A, in which the distance between a vehicle and a stopping point is determined. Method step B, in which the current vehicle speed is determined, follows method step A or even before or at the same time. In a further facultative method step C ambient information is generated, which represent the vehicle surroundings. In another facultative method step D topological information is generated which represents the topology of the vehicle surroundings. The topological information can for example be information regarding uphill gradients and downhill gradients located in driving direction between vehicle and stopping point. In a following method step E a rolling distance to the stopping point which the vehicle can cover alone in a rolling manner with disconnected operational connection between vehicle drive and driven vehicle wheels is determined taking into account at least the current vehicle speed and the distance between vehicle and stopping point. In a facultative manner, the previously mentioned ambient information, the topological information and if applicable further influence quantities can be taken into account when determining the rolling distance in the method step E. On reaching the rolling distance, i.e. when the distance between vehicle and stopping point corresponds to the rolling distance a disconnection signal for disconnecting the operational connection is generated in method step F. In a method step G the operational connection between vehicle drive and driven vehicle wheels is automatically disconnected upon emitting of the disconnection signal.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A device for controlling a driving behavior of a vehicle when approaching a stopping point, comprising:
a sensing device configured to determine a distance between the vehicle and the stopping point;
an evaluation device configured to determine a rolling distance to the stopping point that the vehicle will cover with a disconnected operational connection between a vehicle drive and a driven vehicle wheels and taking into account at least a current speed of the vehicle; and
a signaling device configured to generate a disconnection signal for disconnecting an operational connection when reaching the rolling distance.

2. The device according to claim 1, wherein the disconnection signal is configured to initiate an automatic disconnecting of the operational connection between the vehicle drive and the driven vehicle wheels.

3. The device according to claim 1, wherein the sensing device comprises a camera system.

4. The device according to claim 1,
wherein the sensing device is further configured to generate ambient information that represents surroundings of the vehicle, and
wherein the evaluation device determines the rolling distance taking into account the ambient information.

5. The device according to claim 4, further comprising a navigation device configured to generates topological information representing a topology of vehicle surroundings,
wherein the evaluation device determines the rolling distance taking into account the topological information.

6. A method for controlling a driving behavior of a vehicle on approaching a stopping point, comprising:
determining a distance between the vehicle and the stopping point;
determining a rolling distance to the stopping point taking into account at least the a current speed of the vehicle, wherein the rolling distance is a second distance the vehicle will cover with a disconnected operational connection between a vehicle drive and driven vehicle wheels; and
generating a disconnecting signal configured to disconnect an operational connection upon reaching of the rolling distance.

7. The method according to claim 6, further comprising disconnecting the operational connection between the vehicle drive and the driven vehicle wheels upon receiving the disconnecting signal.

8. The method according to claim 6, further comprising:
generating ambient information that represents vehicle surroundings; and
determining the rolling distance taking into account the ambient information.

9. The method according to claim 8, further comprising:
generating topological information that represents a topology of the vehicle surroundings; and
determining the rolling distance taking into account the topological information.
